(19) United States
(12) Patent Application Publication
(10) Pub. No.: US 2026/0291702 A1
(43) Pub. Date: Sep. 24, 2026

(54) METHOD AND APPARATUS FOR SCHEDULING REQUEST AND SOUNDING REFERENCE SIGNAL TRANSMISSION IN MOBILE COMMUNICATIONS

(71) Applicant: MEDIATEK SINGAPORE PTE. LTD., Singapore (SG)

(72) Inventors: Jozsef Gabor NEMETH, Cambridge (GB); Mohammed S Aleabe AL-IMARI, Cambridge (GB); Sylvio Paul Mathieu BARDES, Cambridge (GB)

(73) Assignee: MEDIATEK SINGAPORE PTE. LTD., Singapore (SG)

(21) Appl. No.: 19/475,392

(22) PCT Filed: Oct. 11, 2024
(86) PCT No.: PCT/CN2024/124102

§ 371 Date: Oct. 14, 2025

Related U.S. Application Data
(60) Provisional application No. 63/589,344, filed on Oct. 11, 2023.

(51) Int. Cl. H04L 5/00

(52) U.S. Cl. CPC H04L 5/0098; H04L 5/0044; H04L 5/0055

(57) ABSTRACT

Various solutions for scheduling request (SR) and sounding reference signal (SRS) transmission with respect to an apparatus in mobile communications are described. The apparatus may determine a signal to be transmitted on a first component carrier (CC). The signal may include a physical uplink control channel (PUCCH) or a first SRS. The apparatus may determine a second SRS to be transmitted on a second CC. The second SRS may overlap with the signal with respect to time domain. The apparatus may transmit the signal and the second SRS.

### CROSS REFERENCE TO RELATED PATENT APPLICATION(S)

The present disclosure is part of a non-provisional application claiming the priority benefit of U.S. Patent Application No. 63/589,344, filed 11 Oct. 2023, the content of which herein being incorporated by reference in its entirety.

### TECHNICAL FIELD

The present disclosure is generally related to mobile communications and, more particularly, to scheduling request and sounding reference signal transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, scheduling request (SR) enables user equipment (UE) to request uplink (UL) grant from network node for data transmission. More specifically, the SR is a special physical layer message from the UE asking the network node for an UL grant to transmit physical uplink shared channel (PUSCH), and the SR indicates that the UE has pending data to transmit and requests the necessary network resources. In addition, sounding reference signal (SRS) is a signal transmitted from the UE to the network node. The network node uses an SRS to determine the quality of the uplink channel, which assists in optimizing resource allocation for data transmission and managing network interference. The process of utilizing SRS enhances overall network performance and ensures efficient communication between the UE and the network node.

However, in some network scenarios across component carriers (CCs), when the UE determines to transmit an SR on one CC and to transmit an SRS on another CC while the SR and the SRS collide with respect to time domain, a transmission arbitration should be performed by the UE and the SRS needs to be dropped, which may cause computational complexity and cumbersome reconfiguration of the remaining SRS symbols over multiple CCs after such transmission arbitration.

Accordingly, how to avoid transmission arbitration between SR and SRS across CCs and the cumbersome reconfiguration of the SRS becomes an important issue in the newly developed wireless communication network. Therefore, there is a need to provide proper schemes to avoid transmission arbitration between SR and SRS across CCs, and the cumbersome reconfiguration of the SRS.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to scheduling request (SR) and sounding reference signal (SRS) transmission with respect to apparatus in mobile communications.

In one aspect, a method may involve an apparatus determining a signal to be transmitted on a first component carrier (CC). The signal may include a physical uplink control channel (PUCCH) or a first sounding reference signal (SRS). The method may also involve the apparatus determining a second SRS to be transmitted on a second CC. The second SRS may overlap with the signal with respect to time domain. The method may further involve the apparatus transmitting the signa and the second SRS.

In one aspect, a method may involve an apparatus transmitting a configuration to a user equipment (UE). The method may also involve the apparatus receiving a signal, which may include a PUCCH or a first SRS, on a first CC and a second SRS on a second CC according to the configuration. The second SRS may overlap with the signal with respect to time domain.

In one aspect, an apparatus may comprise a transceiver which, during operation, wirelessly communicates with a wireless network. The apparatus may also comprise a processor communicatively coupled to the transceiver. The processor, during operation, may perform operations comprising determining a signal to be transmitted on a first CC. The signal may include a PUCCH or a first SRS. The processor may also perform operations comprising determining a second SRS to be transmitted on a second CC. The second SRS may overlap with the signal with respect to time domain. The processor may further perform operations comprising transmitting, via the transceiver, the signal and the second SRS.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to scheduling request (SR) and sounding reference signal (SRS) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may configure a user equipment (UE) network resources for transmitting signals by transmitting a configuration (e.g., a higher layer signaling configuration such as radio resource control (RRC) signaling configuration). After being configured, the UE may determine a signal to be transmitted on a first component carrier (CC). The signal may include: (1) a physical uplink control channel (PUCCH); or (2) a first SRS. Meanwhile, the UE may determine a second SRS to be transmitted on a second CC.

Further, the UE may determine that the signal and the second SRS overlap with respect to time domain, and then the UE may transmit the signal on the first CC and the second SRS on the second CC in the event that the signal overlaps with the second SRS with respect to time domain. Therefore, because the signal (i.e., PUCCH or the first SRS) and the second SRS may be transmitted simultaneously, any transmission arbitration between the signal and the second SRS and cumbersome reconfiguration of the second SRS may be avoided.

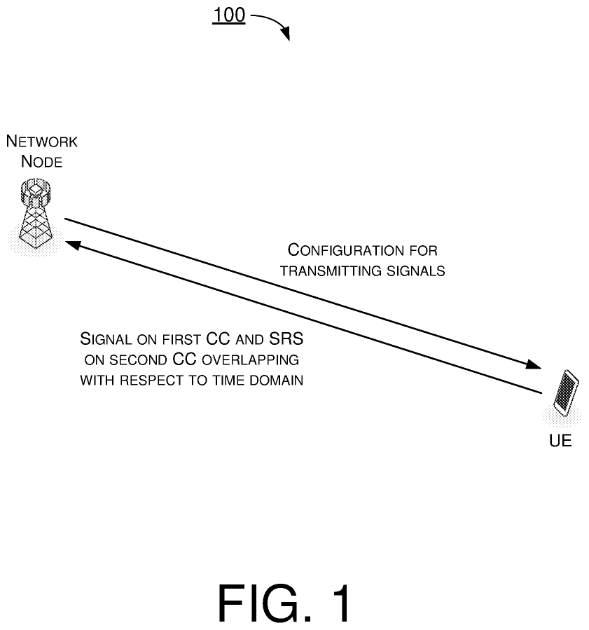

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a configuration to the UE (e.g., RRC configuration). The configuration may indicate to the UE network resources for transmitting signals and/or may enable a function of simultaneously transmitting SR and SRS. After receiving the configuration, the UE may apply the configuration. Accordingly, the UE may determine a signal to be transmitted on a first CC. In other words, the UE may schedule the signal to be transmitted on the first CC. The signal may include: (1) a PUCCH; or (2) a first SRS. Meanwhile, the UE may determine a second SRS to be transmitted on a second CC. In other words, the UE may schedule the second SRS to be transmitted on the second CC.

In particular, the second SRS may be determined to be overlapped with the signal with respect to time domain, and then the UE may transmit the signal and the second SRS in the event the signal overlaps with the second SRS with respect to time domain. In other words, the signal and the second SRS to be transmitted on different CCs (i.e., the first CC and the second CC) may be scheduled to be collided with respect to time domain, and the UE may transmit the signal and the second SRS in the case where the signal and the second SRS collide with respect to time domain.

More specifically, because the UE may transmit the signal on the first CC and the second SRS on the second CC while the signal and the second SRS overlap with respect to time domain, the UE may not need to perform any complicated transmission arbitration between the signal and the second SRS across CCs. In other words, the UE may not need to drop the second SRS while the signal and the second SRS on different CCs collide with respect to time domain. Therefore, a cumbersome reconfiguration of the second SRS due to dropping may be avoided.

In some implementations, the signal may include the PUCCH. In particular, the PUCCH may have PUCCH forma 0 or PUCCH forma 1 (defined in the 3rd generation partnership project (3GPP) specification). In some cases, the PUCCH scheduled to be overlapped with the second SRS may include at least one of an SR and a hybrid automatic repeat request-acknowledgment (HARQ-ACK). In some cases, the PUCCH scheduled to be overlapped with the second SRS may include only the SR, i.e., the UE may not expect any collision to occur between the second SRS and the PUCCH carrying HARQ-ACK.

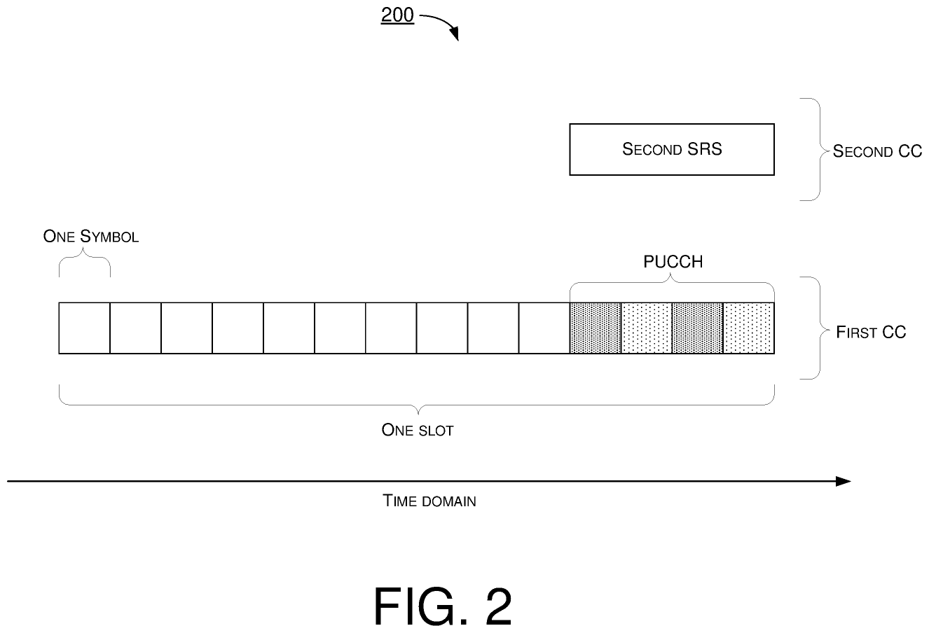

In some implementations, all symbols of the PUCCH within a slot may overlap with the second SRS. FIG. 2 illustrates an example scenario 200 under schemes in accordance with implementations of the present disclosure. In particular, with respect to time domain, the UE may determine that the second SRS on the second CC overlaps with all symbols of the PUCCH on the first CC. In other words, with respect to time domain, the UE may schedule the second SRS on the second CC to overlap with all symbols of the PUCCH on the first CC.

In some implementations, partial symbols of the PUCCH may overlap with the second SRS. In these implementations, a boundary of the second SRS may be scheduled to be aligned with a boundary of a symbol of the PUCCH. In some cases, the symbol may include a demodulation reference signal (DMRS). In some cases, the symbol may be an even symbol of a slot. In some cases, the symbol may be an odd symbol of the slot. In some cases, the boundary of the second SRS may be a starting boundary or an ending boundary.

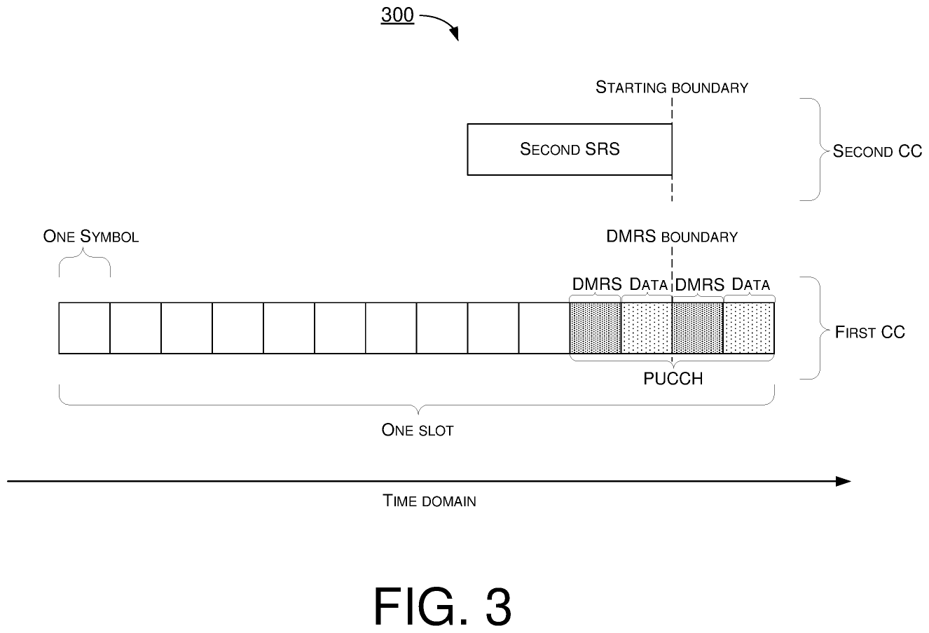

FIG. 3 illustrates an example scenario 300 under schemes in accordance with implementations of the present disclosure. For example, with respect to time domain, the UE determines that a starting boundary of the second SRS on the second CC aligns with a boundary of a DMRS of the PUCCH (e.g., PUCCH having format 0 or format 1 with 4 symbol long, two symbol pairs of DMRS and corresponding data) on the first CC while partial symbols of the PUCCH on the first CC overlap with the second SRS on the second CC. In other words, with respect to time domain, the UE schedules the starting boundary of the second SRS on the second CC to align with the boundary of the DMRS of the PUCCH on the first CC while partial symbols of the PUCCH on the first CC overlap with the second SRS on the second CC. In this example, the starting boundary of the second SRS (e.g., the boundary where the overlap starts) starts after an even symbol (e.g., the second symbol).

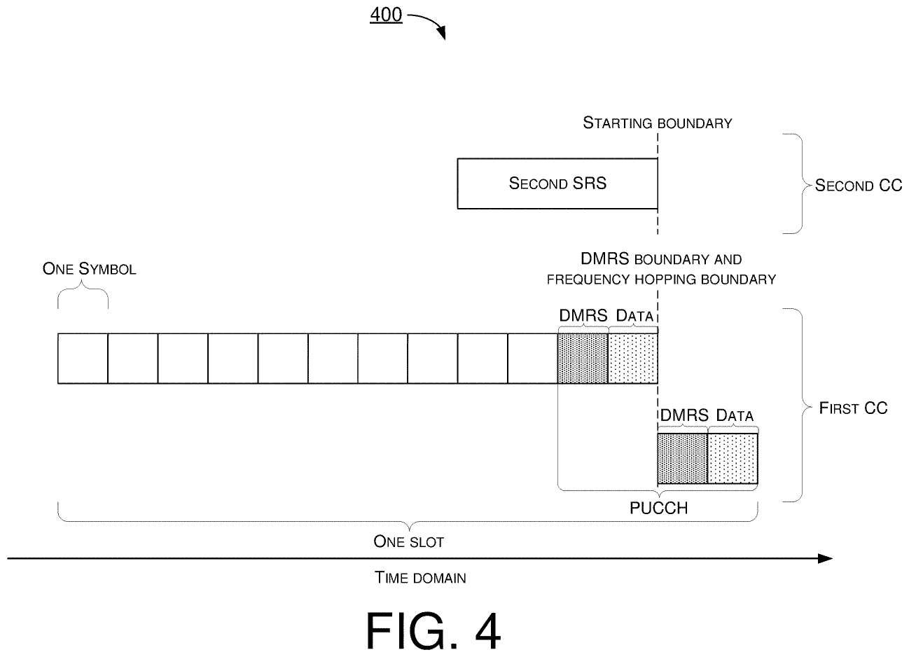

FIG. 4 illustrates an example scenario 400 under schemes in accordance with implementations of the present disclosure. For example, with respect to time domain, the UE determines that a starting boundary of the second SRS on the second CC aligns with: (1) a boundary of a DMRS of the PUCCH (e.g., PUCCH having format 0 or format 1 with 4 symbol long, two symbol pairs of DMRS and corresponding data) on the first CC; and (2) a boundary of frequency hopping (if frequency hopping is performed) while partial symbols of the PUCCH on the first CC overlap with the second SRS on the second CC. In other words, with respect to time domain, the UE schedules the starting boundary of the second SRS on the second CC to align with: (1) the boundary of the DMRS of the PUCCH on the first CC; and (2) the boundary of frequency hopping while partial symbols of the PUCCH on the first CC overlap with the second SRS on the second CC. In this example, the starting boundary of the second SRS (e.g., the boundary where the overlap starts) starts after an even symbol (e.g., the second symbol).

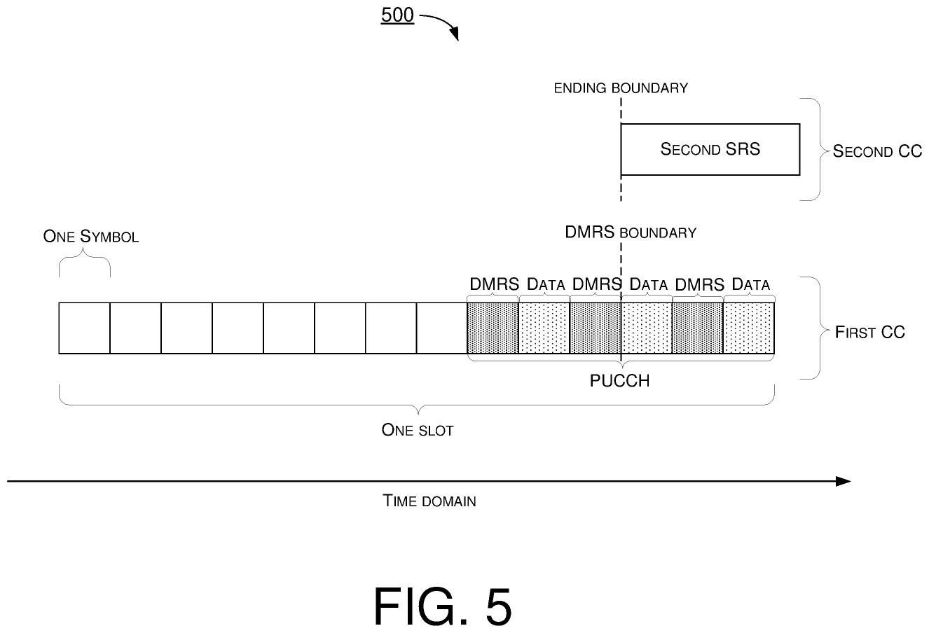

FIG. 5 illustrates an example scenario 500 under schemes in accordance with implementations of the present disclosure. For example, with respect to time domain, the UE determines that an ending boundary of the second SRS on the second CC aligns with a boundary of a DMRS of the PUCCH (e.g., PUCCH having format 0 or format 1 with 6 symbol long, three symbol pairs of DMRS and corresponding data) on the first CC while partial symbols of the PUCCH on the first CC overlap with the second SRS on the second CC. In other words, with respect to time domain, the UE schedules the ending boundary of the second SRS on the second CC to align with the boundary of the DMRS of the PUCCH on the first CC while partial symbols of the PUCCH on the first CC overlap with the second SRS on the second CC. In this example, the ending boundary of the second SRS (e.g., the boundary where the overlap ends) ends after an odd symbol (e.g., the third symbol).

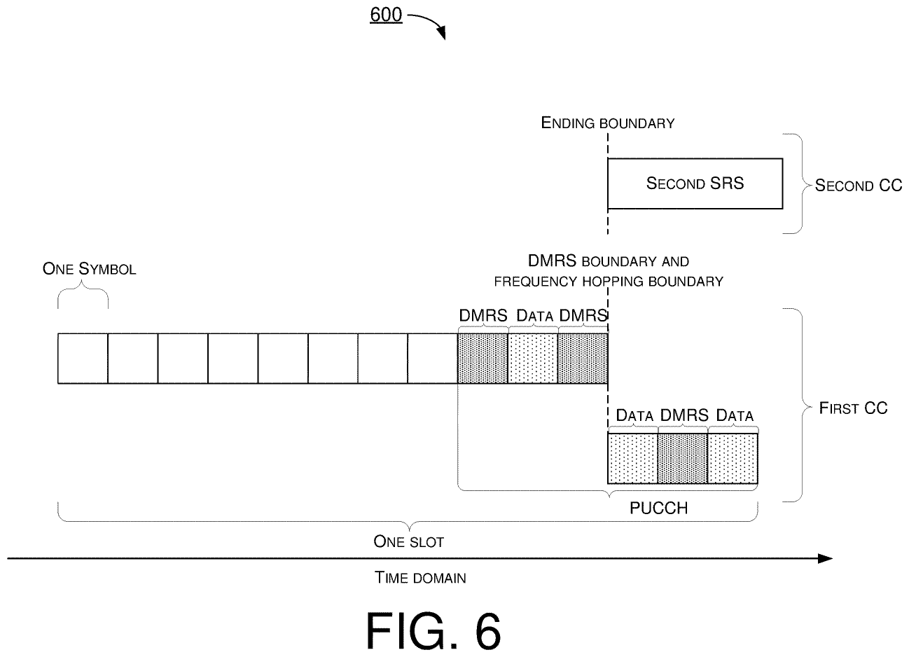

FIG. 6 illustrates an example scenario 600 under schemes in accordance with implementations of the present disclosure. For example, with respect to time domain, the UE determines that an ending boundary of the second SRS on the second CC aligns with: (1) a boundary of a DMRS of the PUCCH (e.g., PUCCH having format 0 or format 1 with 6 symbol long, three symbol pairs of DMRS and corresponding data) on the first CC; and (2) a boundary of frequency hopping (if frequency hopping is performed) while partial symbols of the PUCCH on the first CC overlap with the second SRS on the second CC. In other words, with respect to time domain, the UE schedules the ending boundary of the second SRS on the second CC to align with: (1) the boundary of the DMRS of the PUCCH on the first CC; and (2) the boundary of frequency hopping while partial symbols of the PUCCH on the first CC overlap with the second SRS on the second CC. In this example, the ending boundary of the second SRS (e.g., the boundary where the overlap ends) starts after an odd symbol (e.g., the third symbol).

It should be noted that, in some scenarios, the boundary alignments may be introduced to prevent issues with PUCCH decoding. For example, when transmitting the PUCCH carrying the SR, a phase slip may disrupt, which may break a continuity between DMRS symbol of the SR and corresponding data symbol of the SR, could be introduced to jeopardize the decoding of the PUCCH. Therefore, aligning the boundaries may be necessary to avoid breaking the continuity between DMRS symbol of the SR and corresponding data symbol of the SR. However, it is not intended to limit the purposes and the scopes of the present disclosure.

In some cases, the first CC and the second CC may be respectively within different bands. In some cases, the first CC and the second CC may be within a same band (i.e., the first CC and the second CC may be intra-band CCs). In some cases, the above procedures may be: (1) applicable during a process of performing an SRS carrier switching; and/or (2) enabled selectively per SR configuration. In some cases, the UE may determine to drop the second SRS on the symbols where the overlap occurs.

In some implementations, the signal may include the first SRS. In particular, the second SRS may be determined to be overlapped with the first SRS with respect to time domain, and then the UE may transmit the first SRS and the second SRS in the event the first SRS overlaps with the second SRS with respect to time domain. In other words, the first SRS and the second SRS to be transmitted on different CCs (i.e., the first CC and the second CC) may be scheduled to be collided with respect to time domain, and the UE may transmit the first SRS and the second SRS in the case where the first SRS and the second SRS collide with respect to time domain.

In some cases, the UE may determine to drop one of the SRSs on symbols where the overlap occurs. In some cases, the collision of the SRSs may be only allowed to occur when the colliding channels are configured with the same network numerology. In some cases, the collision of the SRSs may be allowed to occur between different network numerologies.

In some implementations, the UE may perform an SRS-carrier switching procedure with the network node for the second SRS. The UE may determine not to switch the second SRS onto a physical uplink shared channel (PUSCH)-less carrier during the SRS-carrier switching procedure. In other words, the UE may not expect the second SRS being switched on the PUSCH-less carrier to collide with PUSCH or PUCCH carrying HARQ or channel state information (CSI).

### Illustrative Implementations

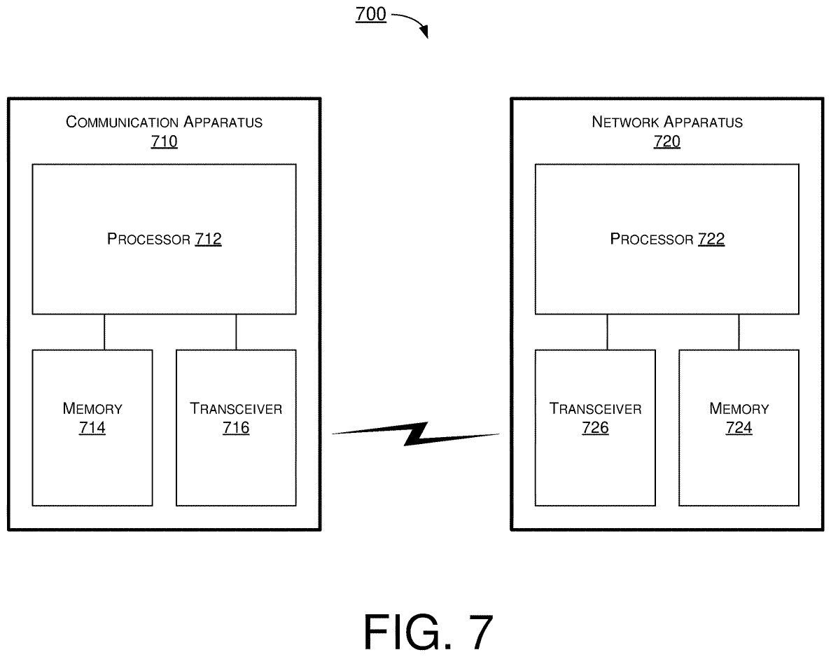

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to SR and SRS transmission with respect to UE and network apparatus in mobile communications, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IloT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including SR and SRS transmission in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In other words, processor 712 may transceive the data such as configuration, message, signal, information, indicator, etc. via transceiver 716. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In other words, processor 722 may transceive the data such as configuration, message, signal, information, indicator, etc. via transceiver 726. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

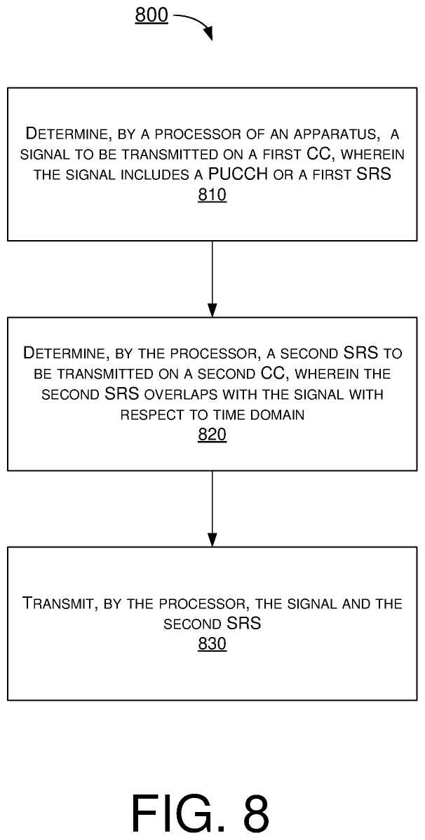

FIG. 8 illustrates an example process 800 in accordance with an implementation of the present disclosure. Process 800 may be an example implementation of above scenarios/schemes, whether partially or completely, with respect to SR and SRS transmission of the present disclosure. Process 800 may represent an aspect of implementation of features of communication apparatus 710. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At block 810, process 800 may involve processor 712 of communication apparatus 710 determining a signal to be transmitted on a first CC. The signal may include a PUCCH or a first SRS. Process 800 may proceed from block 810 to block 820.

At block 820, process 800 may involve processor 712 of communication apparatus 710 determining a second SRS to be transmitted on a second CC. The second SRS may overlap with the signal with respect to time domain. Process 800 may proceed from block 820 to block 830 At block 820, process 800 may involve processor 712 of communication apparatus 710 transmitting the signal and the second SRS.

In some implementations, the PUCCH may have PUCCH format 0 or PUCCH format 1.

In some implementations, the PUCCH may include at least one of an SR and a HARQ-ACK.

In some implementations, all symbols of the PUCCH may overlap with the second SRS.

In some implementations, a boundary of the second SRS may be aligned with a boundary of a symbol of the PUCCH.

In some implementations, the symbol may include a DMRS.

In some implementations, the symbol may be an even symbol of a slot or an odd symbol of the slot.

In some implementations, the boundary of the second SRS is a starting boundary or an ending boundary.

In some implementations, the first CC and the second CC may be respectively within different bands or may be within a same band.

In some implementations, process 800 may involve processor 712 performing an SRS-carrier switching procedure for the second SRS. Process 800 may involve processor 712 determining not to switch the second SRS onto a PUSCH-less carrier during the SRS-carrier switching procedure.

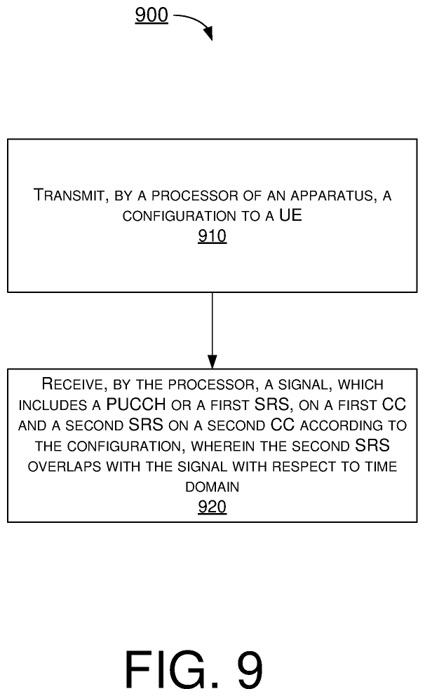

FIG. 9 illustrates an example process 900 in accordance with an implementation of the present disclosure. Process 900 may be an example implementation of above scenarios/schemes, whether partially or completely, with respect to SR and SRS transmission of the present disclosure. Process 900 may represent an aspect of implementation of features of network apparatus 720. Process 900 may include one or more operations, actions, or functions as illustrated by one or more of blocks 910 to 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any suitable network device or machine type devices. Solely for illustrative purposes and without limitation, process 900 is described below in the context of network apparatus 720. Process 900 may begin at block 910.

At block 910, process 900 may involve processor 722 of network apparatus 720 transmitting a configuration to a UE. Process 900 may proceed from block 910 to block 920.

At block 920, process 900 may involve processor 722 of network apparatus 720 receiving a signal, which may include a PUCCH or a first SRS, on a first CC and a second SRS on a second CC according to the configuration. The second SRS may overlap with the signal with respect to time domain.

In some implementations, the PUCCH may have PUCCH format 0 or PUCCH format 1.

In some implementations, the PUCCH may include at least one of an SR and a HARQ-ACK.

In some implementations, all symbols of the PUCCH may overlap with the second SRS.

In some implementations, a boundary of the second SRS may be aligned with a boundary of a symbol of the PUCCH.

In some implementations, the symbol may include a DMRS.

In some implementations, the boundary of the second SRS is a starting boundary or an ending boundary.

In some implementations, the first CC and the second CC may be respectively within different bands or may be within a same band.

In some implementations, process 900 may involve processor 722 performing an SRS-carrier switching procedure with the UE for the second SRS. The UE may determine not to switch the second SRS onto a PUSCH-less carrier during the SRS-carrier switching procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a signal to be transmitted on a first component carrier (CC), wherein the signal includes a physical uplink control channel (PUCCH) or a first sounding reference signal (SRS);
determining, by the processor, a second SRS to be transmitted on a second CC, wherein the second SRS overlaps with the signal with respect to time domain; and
transmitting, by the processor, the signal and the second SRS.

2. The method of claim 1, wherein the PUCCH comprises PUCCH format 0 or PUCCH format 1.

3. The method of claim 2, wherein the PUCCH includes at least one of a scheduling request (SR) and a hybrid automatic repeat request-acknowledgment (HARQ-ACK).

4. The method of claim 1, wherein all symbols of the PUCCH overlap with the second SRS.

5. The method of claim 1, wherein a boundary of the second SRS is aligned with a boundary of a symbol of the PUCCH.

6. The method of claim 5, wherein the symbol includes a demodulation reference signal (DMRS).

7. The method of claim 5, wherein the symbol is an even symbol of a slot or an odd symbol of the slot.

8. The method of claim 5, wherein the boundary of the second SRS is a starting boundary or an ending boundary.

9. The method of claim 1, wherein the first CC and the second CC are respectively within different bands or are within a same band.

10. The method of claim 1, further comprising:
performing, by the processor, an SRS-carrier switching procedure for the second SRS; and
determining, by the processor, not to switch the second SRS onto a physical uplink shared channel (PUSCH)-less carrier during the SRS-carrier switching procedure.

11. A method, comprising:
transmitting, by a processor of an apparatus, a configuration to a user equipment (UE); and
receiving, by the processor, a signal, which includes a physical uplink control channel (PUCCH) or a first sounding reference signal (SRS), on a first component carrier (CC) and a second SRS on a second CC according to the configuration, wherein the second SRS overlaps with the signal with respect to time domain.

12. The method of claim 11, wherein the PUCCH comprises PUCCH format 0 or PUCCH format 1.

13. The method of claim 12, wherein the PUCCH includes at least one of a scheduling request (SR) and a hybrid automatic repeat request-acknowledgment (HARQ-ACK).

14. The method of claim 11, wherein all symbols of the PUCCH overlap with the second SRS.

15. The method of claim 11, wherein a boundary of the second SRS is aligned with a boundary of a symbol of the PUCCH.

16. The method of claim 15, wherein the symbol includes a demodulation reference signal (DMRS).

17. The method of claim 15, wherein the boundary of the second SRS is a starting boundary or an ending boundary.

18. The method of claim 11, wherein the first CC and the second CC are respectively within different bands or are within a same band.

19. The method of claim 11, further comprising:
performing, by the processor, an SRS-carrier switching procedure with the UE for the second SRS, wherein the UE determines not to switch the second SRS onto a physical uplink shared channel (PUSCH)-less carrier during the SRS-carrier switching procedure.

20. An apparatus, comprising:
a transceiver which, during operation, wirelessly communicates with a wireless network; and
a processor communicatively coupled to the transceiver such that, during operation, the processor performs operations comprising:
determining a signal to be transmitted on a first component carrier (CC), wherein the signal includes a physical uplink control channel (PUCCH) or a first sounding reference signal (SRS);
determining a second SRS to be transmitted on a second CC, wherein the second SRS overlaps with the signal with respect to time domain; and
transmitting, via the transceiver, the signal and the second SRS.
